(19) United States
(12) Patent Application Publication
(10) Pub. No.: US 2026/0010785 A1
(43) Pub. Date: Jan. 8, 2026

(54) Quantile Data Pooling Method for a Neural Network

(71) Applicant: Hong Kong Applied Science And Technology Research Institute Co., Ltd., Shatin (HK)

(72) Inventors: Zhoujun Chen, Guangzhou (CN); Xinghua Zhu, Shenzhen (CN); Dongzhe Su, Shenzhen (CN)

(21) Appl. No.: 18/762,897

(22) Filed: Jul. 3, 2024

(51) Int. Cl. G06N 3/08

(52) U.S. Cl. CPC G06N 3/08

(57) ABSTRACT

A computer implemented method of data pooling in a neural network. The method comprises receiving an input tensor formed from a set of data points from an input space, the input tensor having a plurality of input space dimensions. The method includes: segmenting the input tensor over each of its input space dimensions into equal-sized segments, each set of corresponding segments over the input space dimensions comprising a partition; determining, selecting, or calculating a respective quantile level for each partition; determining or calculating a quantile value for each segment based on the quantile level for its partition; and creating a pooled output vector by concatenating the quantile values for the segments of each partition, the output vector comprising a pooled output for each partition.

### FIELD OF THE INVENTION

The invention relates to a quantile data pooling method for a neural network and particularly, but not exclusively, to a quantile data pooling method for enhanced feature representation in set-structured data analysis.

### BACKGROUND OF THE INVENTION

In many domains, including computer vision, natural language processing, bioinformatics, autonomous driving, etc., data is naturally represented as sets or bags of features. For instance, a document can be viewed as a set of words or sentences, molecular structures can be represented as sets of atoms or bonds, and point clouds can be viewed as a set of coordinates. The analysis of such set-structured data requires methods that are invariant to permutations of the data elements and sensitive to the distribution of features within the set.

A general model for set-structured data analysis would typically consist of the following components: feature extraction; feature aggregation; feature transformation; learning algorithm; and inference and prediction. The process begins with the extraction of features from each element within a set. This step transforms raw data into a format that is amenable to analysis, such as vectors in a high-dimensional space. Once features are extracted, they need to be aggregated in a way that respects the unordered nature of sets. This is where pooling methods, such as the traditional maximum (“max”) and average pooling come into play, summarizing the information across the entire set. High-dimensional feature vectors can go through several levels of transformations to finally reach the output space, where predictions are made. The processed features are then fed into a learning algorithm. This could be a supervised model, like a classifier or regressor, or an unsupervised model, like a clustering algorithm, depending on the task at hand. The final step involves making inferences or predictions based on the model's output. This could mean classifying a document into a category, predicting the properties of a molecule, or identifying objects within a point cloud.

One problem is that traditional pooling methods like max pooling and average pooling have limitations in capturing the full spectrum of feature importance within the data set. The known methods of data pooling may overlook critical nuances or be misled by anomalies in the data.

What is desired among other things is an improved data pooling method.

### OBJECTS OF THE INVENTION

An object of the invention is to mitigate or obviate to some degree one or more problems associated with known data pooling methods.

The above object is met by the combination of features of the main claims; the sub-claims disclose further advantageous embodiments of the invention.

Another object of the invention is to provide an improved data pooling method for set-structured data analysis.

Another object of the invention is to enhance how neural networks interpret and summarize set-structured data.

A yet further object of the invention is to provide a more nuanced and adaptable data pooling approach, enabling the neural network to capture the essential elements of the data without losing sight of the overall context or being skewed by outliers.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a computer implemented method of data pooling in a neural network comprising: receiving an input tensor formed from a set of data points obtained from an input space, the input tensor having a plurality of input space dimensions; segmenting the input tensor over each of its input space dimensions into equal-sized segments, each set of corresponding segments over the input space dimensions comprising a partition; determining, selecting, or calculating a respective quantile level for each partition; determining or calculating a quantile value for each segment based on the quantile level for its partition; and creating a pooled output vector by concatenating the quantile values for the segments of each partition, the output vector comprising a pooled output for each partition.

In a second main aspect, the invention provides a neural network incorporating a quantile pooling layer for permutation-equivariant set data analysis, the network comprising: means for receiving an input tensor comprising a set of unordered data points; means for processing the input tensor through one or more permutation-equivariant transformations and/or one or more non-linear layers; and means for processing the input tensor through a quantile pooling layer to produce a pooled output by performing the quantile data pooling method of the first main aspect to provide a pooled output vector.

In a third main aspect, the invention provides a computer system for set data analysis, the computer system comprising: means for collecting a set of data points; means for performing permutation-equivariant transformations and quantile pooling on the collected data points according to the method implemented in the second main aspect; and means for utilizing the output vector or tensor to implement operations or tasks involving set-structured data.

The invention may provide a non-transitory computer-readable medium storing machine-readable instructions, wherein, when the machine-readable instructions are executed by a processor, they configure the processor to implement the method of any aspect of the invention.

The summary of the invention does not necessarily disclose all the features essential for defining the invention; the invention may reside in a sub-combination of the disclosed features.

The forgoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a graph showing the δ quantile pooling density function centered at a value q;

FIG. 2 schematically illustrates a relaxed quantile pooling method in accordance with the invention;

FIG. 3A is a graph showing the relaxed quantile pooling density function in accordance with the invention concentrated close to a value 1;

FIG. 3B is a graph showing the relaxed quantile pooling density function in accordance with the invention distributed uniformly from value 0 to value 1;

FIG. 3C is a graph showing the relaxed quantile pooling density function in accordance with the invention with a high quantile interval center and a wide quantile interval;

FIG. 3D is a graph showing the relaxed quantile pooling density function in accordance with the invention having a quantile range provided by a learning algorithm and where the probability density function for the quantile range is non-uniformly distributed from value 0 to value 1;

FIG. 4 shows an example of the quantile pooling operation in accordance with the invention;

FIG. 5 schematically illustrates an embodiment of a neural network in which the method of the invention can be implemented;

FIG. 6 schematically illustrates the method performed by the neural network of FIG. 5;

FIG. 7 schematically illustrates the method performed by the neural network of FIG. 5 with multiple quantile pooling layers;

FIG. 8 is a graph plotting the quantile pooling density function over the quantile range or interval for different scenarios;

FIG. 9A shows sorting clusters visualized as points;

FIG. 9B shows sorting clusters shuffled and then sorted;

FIG. 10 is a graph plotting accuracy against different poling methods;

FIG. 11 shows modelled results for different pooling methods;

FIG. 12 schematically illustrates one embodiment of a computer-implemented system according to the invention; and

FIG. 13 illustrates a vehicle-to-everything (V2X) system in which the computer-implemented system of FIG. 12 may be employed for implementing the relaxed quantile pooling method in accordance with the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which May be requirements for some embodiments, but not other embodiments.

It should be understood that the elements shown in the drawings may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The present invention combines the strengths of max pooling and average pooling, emphasizing both salient features and the overall data distribution. The present invention provides adjustability to customize the quantile data pooling method more towards max pooling for some applications, or more towards average pooling for other applications, or a combination of both max pooling and average pooling, or even a completely customized quantile pooling method for yet other applications.

A quantile is a statistical concept that divides a probability distribution or data set into equal-sized intervals or portions. It represents a specific value below which a certain proportion of the data falls.

In probability theory, a probability space or a probability triple (Ω, [symbol] , P) is a mathematical construct that provides a formal model of a random process or “experiment”. A probability space consists of three elements: (i) a sample space, Ω, which is the set of all possible outcomes; (ii) an event space, which is a set of events, [symbol] , an event being a set of outcomes in the sample space; and (iii) a probability function, P, which assigns, to each event in the event space, a probability, which is a number between 0 and 1 (inclusive).

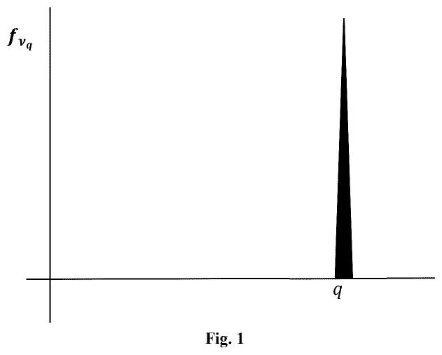

The mathematical foundation of quantile pooling comprises, for a probability space (Ω, [symbol] , P) and a random variable X:Ω→ [symbol] with cumulative distribution function F_{X}: [symbol] →[0,1] where X has bounded support, a function [symbol] : [symbol] → [symbol] such that, for a given quantile q∈[0, 1], the quantile pooling function [symbol] _{q}(X) is given as:

$${𝒫}_{q} ( X ) = {\int }_{0}^{1} {Q}_{X} ( p ) {f}_{{v}_{q}} dp .$$

where Q_{X}(p) is the quantile function, the inverse of F_{X}, and ƒ_{ν}_{_{q}}, is the density function associated with measure ν. More specifically, in the case of δ quantile pooling which allows for flexibility of capturing specific quantiles, the density function comprises a Dirac delta function δ(p−q) centred at q. When ƒ_{ν} is the Dirac delta function δ(p−q) centered at q, the quantile pooling function [symbol] _{q}(X) is referred to as δ Quantile Pooling. Referring to the drawings, FIG. 1 illustrates the δ quantile pooling density function centered on point q.

The present invention can be considered as comprising ‘relaxed’ quantile pooling where ƒ_{ν}_{_{q}} is a density function that has its density distributed across a quantile range [q−∈, q+∈] where ∈ is the size of the range on either side of the point q instead of being centered on the single point q. The quantile pooling function [symbol] _{q}(X) becomes the relaxed quantile pooling method implemented by the present invention. Preferably, the density function ƒ_{νq} for a quantile range for the respective quantile levels of the present invention comprises the Dirac delta function δ(p−q) centered on q with a quantile range of q+/−∈, i.e., [q−∈, q+∈]. In practice, relaxed quantile pooling operates in any D-dimensional space [symbol] ^{D}. Therefore, given an input tensor X∈ [symbol] ^{N×D}, which comprises a set of N vectors over the D-dimensional space [symbol] ^{D}, quantile pooling outputs an aggregated global vector g∈ [symbol] ^{D}, where gᵢ= [symbol] _{q}(Xᵢ), i∈{1, 2, . . . , D}, but q is not necessarily the same for all i. A tensor is a vector or matrix of n-dimensions that represents all types of data. All values in a tensor hold identical data type with a known (or partially known) shape. The shape of the data is the dimensionality of the matrix or array.

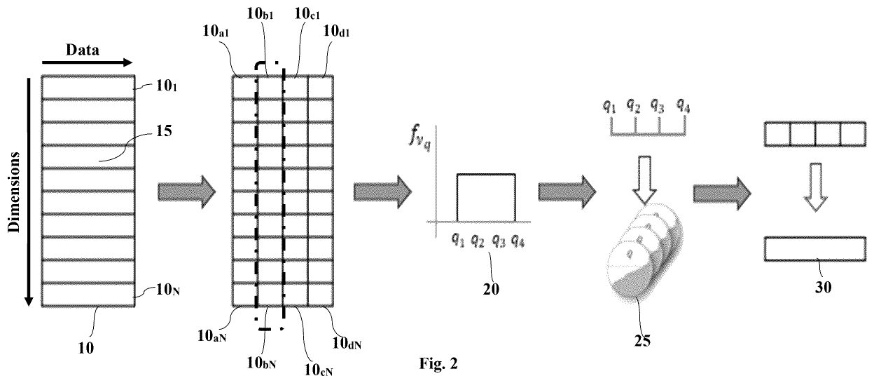

Referring to the drawings, FIG. 2 schematically illustrates a method in accordance with the first main aspect of the invention. A first step of the method comprises receiving an input tensor 10 formed from a set of data points obtained from an input space. In some embodiments, the input space may refer to a spatial domain of the input data, typically an image or a feature map, on which the quantile pooling operation is to be applied. The input space therefore represents the raw data or feature representation before any pooling is performed. The data 15 comprising the set of data points obtained from the input space is distributed over a plurality of input space dimensions 10₁ to 10ₙ of the input tensor 10. The input space could comprise any suitable domain, such as, for example, computer vision, natural language processing, bioinformatics, autonomous driving, etc. The set of data points could, for example, comprise point cloud data. The point cloud data may comprise data points defining objects and their locations within an environment. An example of an environment may be a road traffic environment. The first step of the method may include preparing or compiling the set of data points obtained from the input space into the input tensor 10.

In a next step of the method, the input tensor 10 is segmented over each of its input space dimensions into a plurality of equal-sized segments denoted respectively in FIGS. 2 as: 10ₐ₁ to 10_{aN}; 10_{b1} to 10_{bN}; 10_{c1} to 10_{cN}; and 10_{d1} to 10_{dN}. It will be understood that there may be more or less segments than illustrated in FIG. 2. Each segment contains a subset of the data 15. Each set of corresponding segments over the input space dimensions 10₁ to 10ₙ comprises a partition of the input tensor 10. The dashed box in FIG. 2 identifies, for ease of reference and by way of example only, one of the partitions comprising segments 10_{b1} to 10_{bN} over the input space dimensions 10₁ to 10ₙ. Whilst only four partitions are shown in FIG. 2, it will be understood that there may be more than four partitions or less than four partitions.

In a next step of the method, for the segments in each partition, specific quantile levels (as denoted by numeral 20 in FIG. 2) are determined, selected, or calculated according to a predefined or learnable density function of a quantile level. The density function is preferably a probability density function. The quantile levels are different for each partition. The quantile levels preferably comprise points within the data distribution that will be used to capture the statistical characteristics of the input tensor 10. Each segment within a partition has the same quantile level applied thereto so the number of determined, selected, or calculated quantile levels equals the number of partitions.

A next step of the method comprises determining or calculating a quantile value for each segment based on the quantile level for its partition. In one embodiment of the method, within each segment, the method applies partition sorting operation which rearranges the data within the partition so that certain elements, known as “pivot elements,” are in their final sorted position. Once the pivoting is done, interpolation may be used to estimate the quantile values. Interpolation is necessary when the quantile level does not correspond to an actual value in the dataset and the value needs to be estimated by considering the values on either side of the quantile position.

A next step of the method comprises concatenating the quantile values for the segments of each partition (as denoted by numeral 25 in FIG. 2) to create a pooled output vector or tensor 30. This is achieved by concatenating the quantile values for the segments of each partition such that the output vector or tensor 30 comprises a pooled output for each partition of the input tensor 10. The output vector or tensor 30 represents the statistical distribution of the entire input tensor 10.

The resulting pooled output 30 serves as a feature representation of the input data. It effectively captures the distribution by focusing on specific quantiles within each segment thereby providing a summary that can be used for further processing within the neural network.

Preferably, the quantile range is adjustable to provide a custom data pooling function for the neural network.

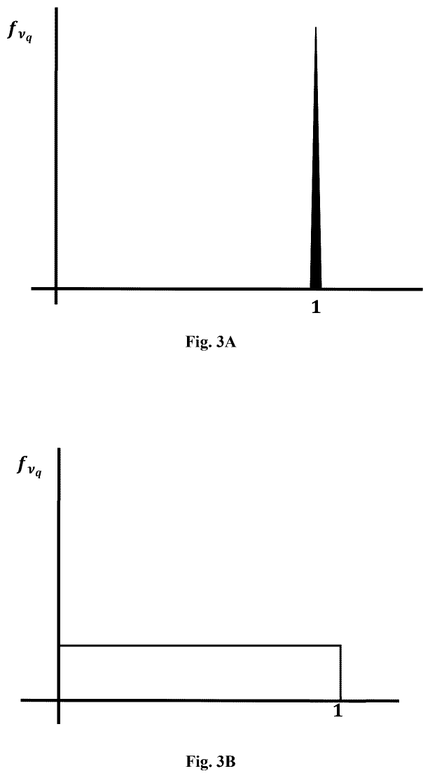

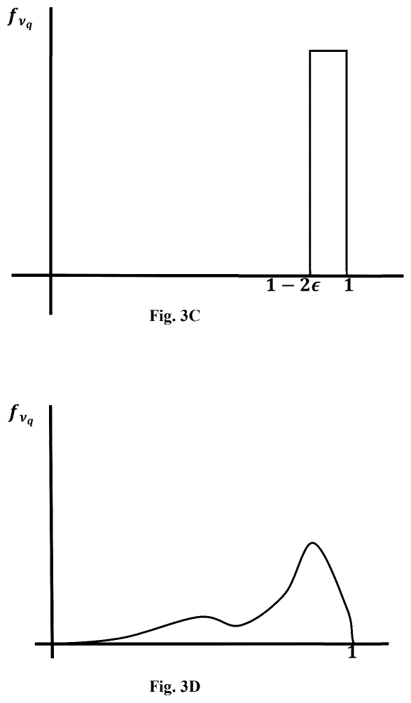

In one embodiment as illustrated in FIG. 3A, the probability density function ƒ_{νq} for the quantile range is concentrated close to a value 1 to approximate the maximum pooling operation.

In another embodiment as illustrated in FIG. 3B, the probability density function ƒ_{νq} for the quantile range is distributed uniformly from value 0 to value 1 to approximate the average pooling operation.

In yet another embodiment as illustrated in FIG. 3C, the probability density function ƒ_{νq} for the quantile range is selected to have a high quantile interval center and a wide quantile interval to enhance versatility in capturing data features and data distribution. In one embodiment, the quantile range is selected to be in the range from 0.9 to 1. This has been found to be a very versatile range for data pooling in set-structured data environments.

In a further embodiment as illustrated in FIG. 3D, the probability density function ƒ_{νq} for the quantile range is learned via a learning algorithm with the probability density function ƒ_{νq} for the quantile range being non-uniformly distributed from value 0 to value 1.

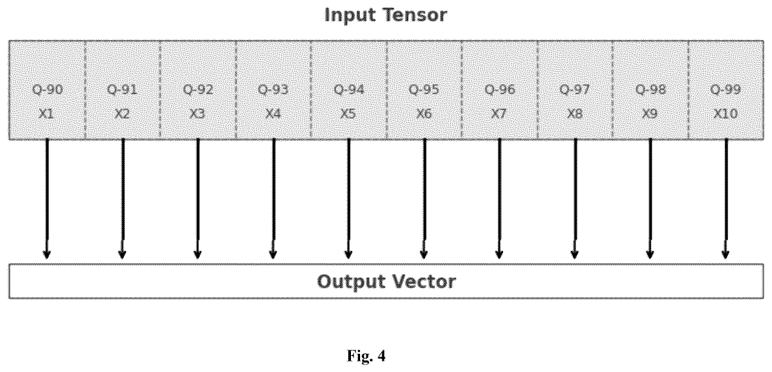

FIG. 4 shows an example of the quantile pooling operation or layer where the quantile levels selected for segments X1 to X10 comprise the 90^{th} to the 99^{th} quantiles. The implementation of the quantile pooling operation of FIG. 4 is detailed in the algorithm below.

In short, the algorithm divides the input tensor along its dimensions into equal-sized segments. Within each segment, it calculates specified quantile levels by partition sorting and interpolation for quantile estimation. The quantile values across all segments are then concatenated to form the final pooled output as an output vector or tensor, capturing the statistical distribution of the input tensor effectively.

Algorithm 2 Quantile Pooling Layer

Require: Tensor X ∈ [symbol] ^{N×D}, quantile q, epsilon ϵ, number of intervals k
Ensure: Vector y ∈ [symbol] ^{D}

| | |
|---|---|
| 1: | Initialize vector q for quantile levels |
| 2: | for i < 1 to k do |
| 3: | ${q}_{level} ← q - ϵ + ( \frac{2 ϵ i}{k} )$ |
| 4: | Append qₗₑᵥₑₗ to q |
| 5: | end for |
| 6: | $segment\_width ← ⌊ \frac{D}{k} ⌋$ |
| 7: | Initialize the output vector y ← [ ] |
| 8: | for i ← 1 to k do |
| 9: | start_index ← (i − 1) · segment_width |
| 10: | end_index ← i · segment_width |
| 11: | X_{segment} ← X[:, start_index : end_index] |
| 12: | Sort X_{segment} along the N dimension |
| 13: | Initialize y_{segment} ←[ ] |
| 14: | for all qₗₑᵥₑₗ in q do |
| 15: | h ← (N + 1) · qₗₑᵥₑₗ |
| 16: | if h is an integer then |
| 17: | quantile_estimate ← X_{segment}_sorted[h] |
| 18: | else |
| 19: | lower ← X_{segment}_sorted [ └h┘ ] |
| 20: | upper ← X_{segment}_sorted [ ┌h┐ ] |
| 21: | quantile_estimate ← lower + (upper − lower) · (h − └h┘ ) |
| 22: | end if |
| 23: | Append quantile_estimate to y_{segment} |
| 24: | end for |
| 25: | Concatenate y_{segment} to y |
| 26: | end for |
| 27: | return y |

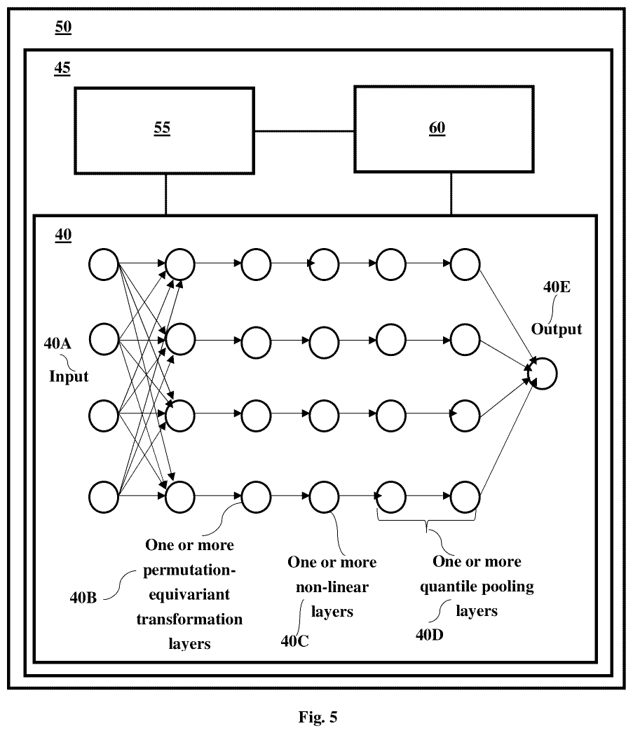

FIG. 5 schematically illustrates a neural network 40 in which the method of the invention can be implemented. The neural network 40 may include or comprise a decision-making module 45. The decision-making module 45 may itself comprise or form part of a computer-implemented system 50, the computer-implemented system 50 including a memory 55 for storing machine-readable instructions and a processor 60 for executing said machine-readable instructions to cause any of the neural network 40, the decision-making module 45 or the computer-implemented system 50 to implement the method of the invention.

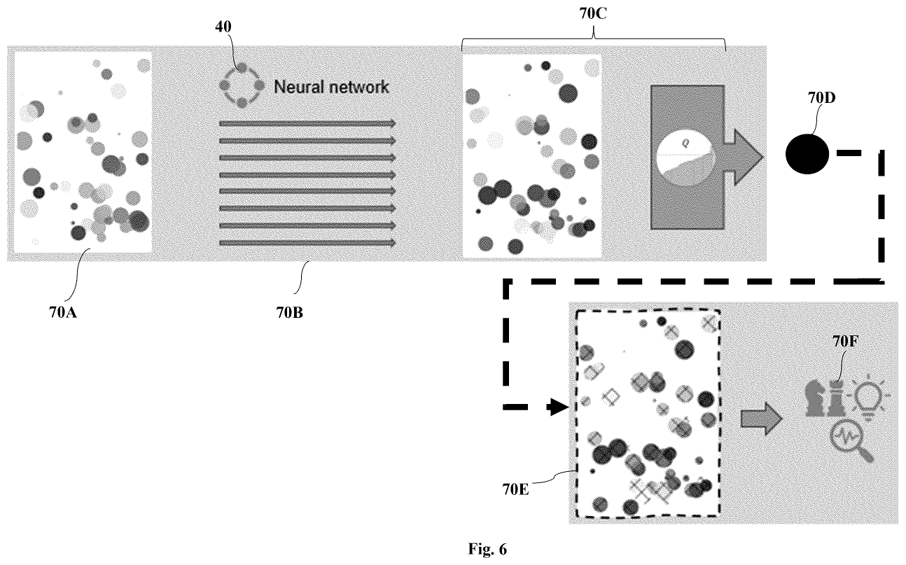

More specifically, the neural network 40 incorporates at least one quantile pooling operation layer for permutation-equivariant set data analysis. The method performed by the neural network 40 is illustrated by FIG. 6. As denoted by numeral 70A in FIG. 6, the neural network 40 receives at an input 40A to the neural network 40 an input tensor 10 (FIG. 2) comprising a set of unordered data points. Under control of the processor 60 executing the machine-readable instructions stored in the memory 55, the neural network 40 processes the received the input tensor 10 through one or more permutation-equivariant transformation layers 40B and/or one or more non-linear layers 40C as denoted by numeral 70B.

In traditional neural networks, the order of input elements matters, and changing the order of the inputs will result in different outputs. However, permutation-equivariant transformations ensure that the output of the transformation remains the same regardless of the order of the input elements. One example of a permutation-equivariant transformation is the max-pooling operation. Max-pooling extracts the maximum value from a set of inputs, and it remains unchanged regardless of the order in which the inputs are presented. This property makes max-pooling permutation-equivariant.

Non-linear layers are an important component of deep neural networks. In a neural network, a non-linear layer introduces non-linearities into the network's computations, allowing the network to learn complex relationships and make more expressive predictions. Without non-linearities, neural networks would be limited to expressing linear relationships, severely constraining their modelling capabilities.

The neural network 40 preferably includes a learning algorithm to determine or select the probability density function ƒ_{νq} for the quantile range such as those illustrated by FIGS. 3A to 3D.

As denoted by numeral 70C, the neural network 40 then processes the input tensor 10 through at least one quantile pooling layer 40D to produce a pooled output to provide at an output 40E (final output space) of the neural network 40 a pooled output vector 70D. The at least one quantile pooling layer 40D processes the input tensor 10 in the manner described with respect to FIG. 2.

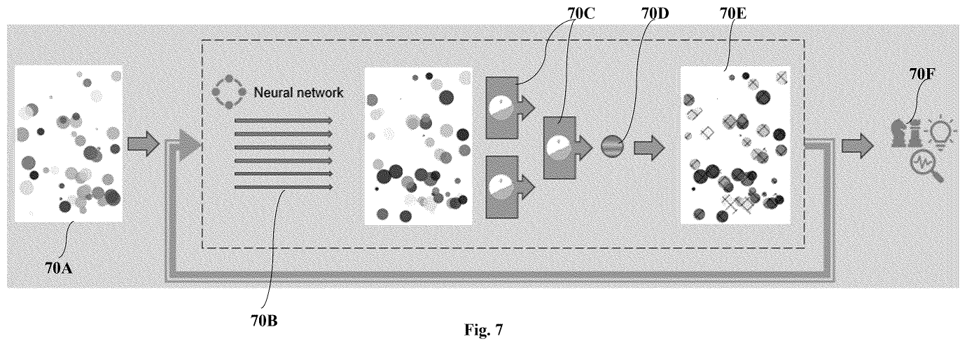

As denoted by numeral 70E, the neural network 40 under control of the processor 60 may concatenate the pooled output vector 70D with or without the input tensor 10 to provide a concatenated tensor 70F to the final output space. The neural network 40 may also process the concatenated tensor 70F or the pooled output vector 70D through one or more element-wise transformations and/or one or more additional non-linear layers. An element-wise transformation, also known as pointwise transformation, refers to a type of operation or transformation that is applied independently to each element of a given set, vector, or tensor. In other words, the transformation is performed on each element individually without considering any relationships or interactions between elements.

Where the neural network 40 has multiple quantile pooling layers as shown in FIG. 7, each quantile pooling layer may use a different quantile level or quantile range so different layers of pooling use different quantile levels or quantile ranges. Multiple pooling layers or multiple compositions of pooling layers and transformation layers can be effective in the same neural network. They may operate in sequence as a pipeline or in parallel.

More specifically, the computer-implemented system 50 which, in one embodiment, comprises the decision-making module 45 and the neural network 40, is arranged to receive or collect a set of data points. The computer-implemented system 50 processes the set of data points in the manner of the method depicted by FIG. 2 and performs permutation-equivariant transformations and quantile pooling on the collected data points in the manner depicted by FIG. 6 and/or FIG. 7. The computer-implemented system 50 preferably utilizes the output vector or tensor 70D, 70F to implement operations or tasks involving set-structured data. Self-structured data or structured data refers to data that is organized and formatted in a specific way. Examples of computer-implemented systems 50 having self-structured data include self-driving vehicle systems including self-driving vehicles, and smart transportation systems including smart transportation devices.

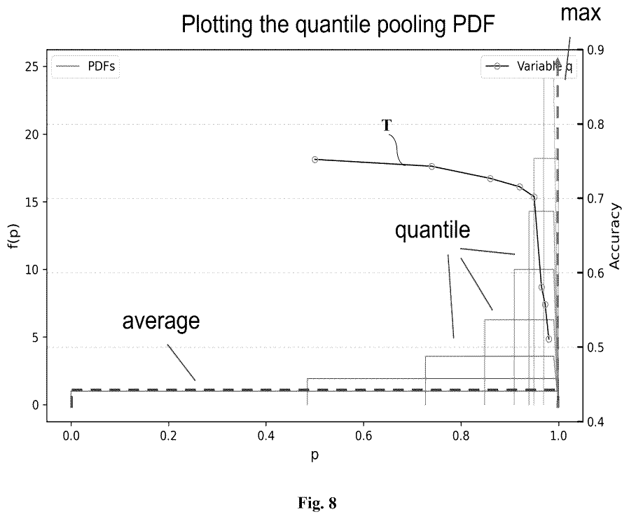

Referring to FIG. 8 which provides a graph plotting the quantile pooling density function over the quantile range or interval for different scenarios, it can be seen that quantile pooling with a density function spread over an interval [q−∈, q+∈] approximates average pooling as ∈ approaches a value of 0.5. Hence, in this scenario, quantile pooling shares the attributes of average pooling. These attributes include sensitivity and comprehensiveness.

In contrast, quantile pooling approximates max pooling as the value of q→1, with the density function concentrated in the interval [1−2∈,1]. Hence, in this scenario, quantile pooling shares the attributes of max pooling. These attributes include robustness and discernment.

The relaxed quantile pooling method of the present invention can be implemented as average pooling or max pooling or for other selected quantile intervals to provide greater versatility. Consequently, the relaxed quantile pooling method of the present invention serves as a versatile intermediary between average and max pooling as indicated by the denoted quantiles in FIG. 8. By adjusting the parameters ∈ and q, the relaxed quantile pooling method of the present invention can be fine-tuned to prioritize either sensitivity or robustness. Relaxed quantile pooling with q˜0.95 and ∈˜0.05 has been found to be versatile and yields strong results. Relatively high quantile levels and a sufficiently wide quantile range provide enough adaptability to balance between max pooling and average pooling and take advantage of both by capturing key data features while accounting for the broader distribution.

As shown in FIG. 8, varying the quantile level q and the relaxation parameter e to transition the quantile pooling functions results in a smooth transition between max pooling and average pooling as indicated by the graph line T. In this instance, the data simulation was conducted on a sorting clusters problem which favours average pooling.

In terms of computational efficiency, relaxed quantile pooling method of the present invention has comparable inference times to max pooling and average pooling, unlike other alternative pooling methods. It is also known that the inference time is little sensitive to the choice of partitioning parameter k. Quantile pooling introduces very little overhead compared to other alternative pooling methods. Adding some extra parameters (increasing width) or layers (increasing depth) to quantile pooling networks improves performance like learned pooling methods but is still much quicker.

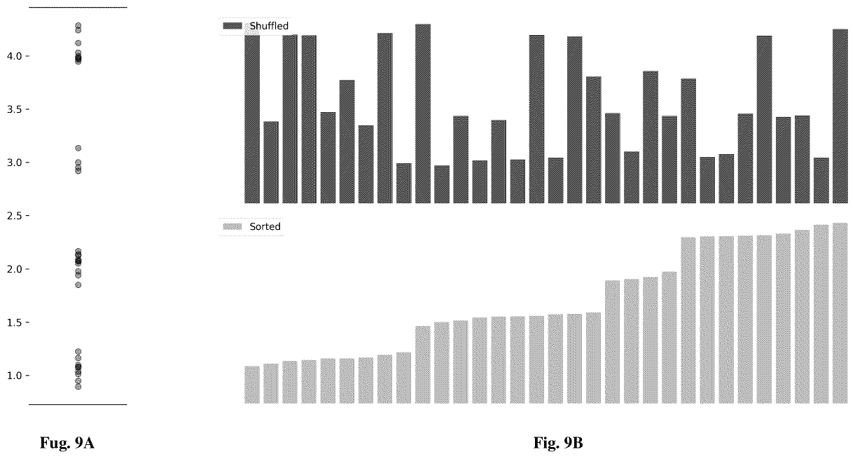

The sorting cluster problem serves as a practical scenario to understand how different pooling strategies handle perturbations within a set. FIG. 9A shows clusters visualized as points. FIG. 9B shows the clusters shuffled (upper part of FIG. 9B) and sorted (lower part of FIG. 9B). To address the sorting clusters issue, a multiset X is constructed by sampling n integers from a uniform distribution over [symbol] . Repeated elements are included to ensure that the multiset forms small clusters, with each integer xᵢ∈X subjected to a uniform perturbation ∈˜U(−0.1, 0.1), such that the perturbed set X′={xᵢ+∈|xᵢ∈X}. A model is tasked to predict the sorted index for each element.

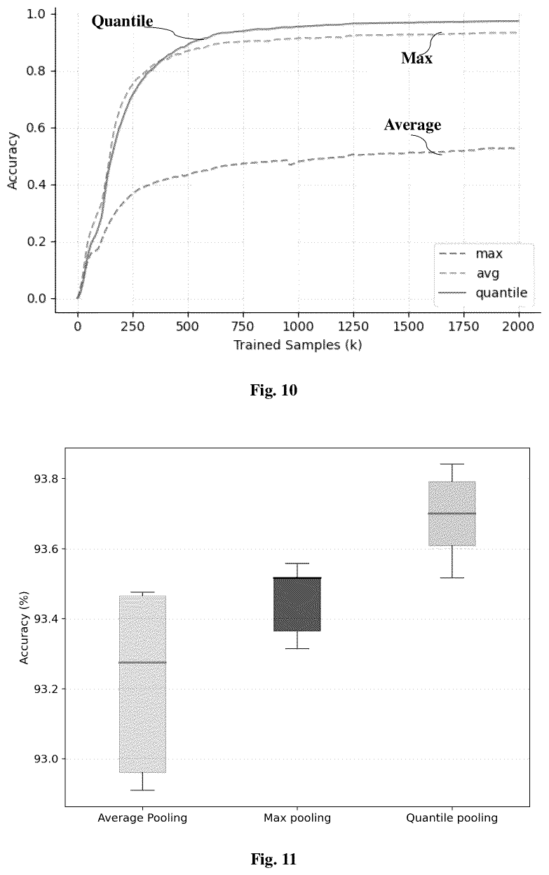

In experiments conducted on a DeepSets-like neural network to compare different pooling strategies, the results of FIG. 10 are obtained. The tendency of average pooling to be sensitive to minor changes enables it to preserve the order within smaller data clusters. In contrast, max pooling tends to fall short in these scenarios due to its disregard for subtle differences among set elements, opting to only retain the most dominant value. The relaxed quantile pooling method of the present invention, particularly with a high quantile (e.g., q=0.95, ∈=0.05), effectively retains the intricate structure of these clusters while also accounting for the broader distribution, leading to superior results. It has been found that relaxed quantile pooling method of the present invention is sensitive to perturbations and can detect subtle details like average pooling, even with a high quantile range [0.9,1]. It has also been found that the quantile pooling method of the invention can do better than average pooling because it also overcomes limitations of average pooling, highlighting its versatility.

The quantile pooling method of the invention is particularly versatile with processing a set of data points obtained from an input space comprising point cloud data. Point cloud classification is a critical task within the realm of set analysis that involves categorizing the raw 3D point data typically gathered by, for example, LiDAR sensors into distinct classes or labels. It involves grouping unordered points into meaningful categories. It is key for obstacle detection and avoidance in self-driving cars. It supports real-time decision-making for safe and efficient navigation. It supports real-time decision-making for safe and efficient navigation. It facilitates advanced vehicle-to-everything (V2X) communication and coordination.

When applied to point cloud data obtained from an environment such as a self-driving car environment, the quantile pooling method of the invention outperforms max pooling, which, in turn, outdoes average pooling. Max pooling proves better than average pooling in complex scenarios without intentional perturbations in, for example, the sorting procedure. In such an environment, comprehensiveness and discernment are both important abilities for recognizing the overall shape of objects (e.g., vehicles) well. Robustness makes sure the model can generalize to unseen classes, and sensitivity enables capturing of elaborate shape variations. The versatility of the quantile pooling method of the invention is highlighted by its superior performance which demonstrates its adaptability and effectiveness as a robust component in a point cloud neural network.

Referring to FIG. 11, the quantile pooling method of the invention was tested on a ModelNet40 dataset, within a PointMLP model, a strong baseline and well-established framework, as described in Ma, Xu, et al. “Rethinking network design and local geometry in point cloud: A simple residual MLP framework.” arXiv preprint arXiv:2202.07123 (2022). Average pooling and the quantile pooling method of the invention were tested by replacing all max pooling layers in PointMLP. The results of the experiment after 6 runs for each pooling method are shown in FIG. 11.

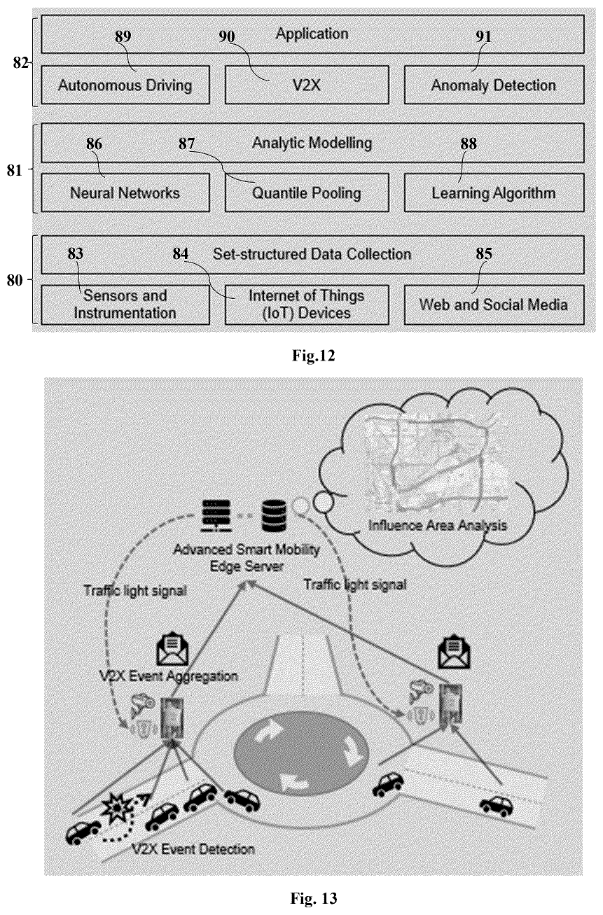

FIG. 12 schematically illustrates one embodiment of a computer-implemented system 50 according to the invention.

The computer-implemented system 50 of FIG. 12 may be configured to operate in a V2X system as illustrated in FIG. 13. In this environment, the computer-implemented system 50 comprises a V2X event-driven bottom-up data collection and processing mechanism. The computer-implemented system 50 of FIG. 12 comprises means 80 for collecting a set of data points, means 81 for performing permutation-equivariant transformations and quantile pooling on the collected data points according to the method of the invention, and means 82 for utilizing the output for tasks involving set-structured data, such as self-driving vehicles and smart transportation systems. The means 80 for collecting a set of data points may comprise any or all sensors or instruments 83 operating in the V2X system and may involve any or all Internet of Things (IoT) devices 84 operating in the V2X system, and web and social media devices 85 operating in the V2X system. The means 81 for performing permutation-equivariant transformations and quantile pooling on the collected data points may comprise one or more neural networks 86, a quantile pooling module 87 for executing the quantile pooling method of the invention, and a learning algorithm module 88 implementing one or more learning algorithms as hereinbefore described. The means 82 for utilizing the output for tasks involving set-structured data may comprise an autonomous driving module 89, a V2X control module 90, and a V2X anomaly detection module 91.

FIG. 13 is illustrative of a V2X edge system which is essential for improving road safety and traffic flow by facilitating real-time communication between vehicles and infrastructure, sharing crucial information on traffic conditions and road hazards. However, the rapid and precise evaluation of traffic events and their impacts remains a challenge, as traditional neural network pooling methods like max or average pooling often fall short in effectively capturing the intricate details of traffic data.

Applying the quantile pooling method of the invention to the V2X edge system of FIG. 13, it is necessary to detect V2X events. LiDAR and other sensors in the V2X edge system detect traffic events. The sensor data, which is preferably in the form of point cloud data, is fed into a neural network such as provided by or comprising the computer-implemented system 50 of FIG. 12. The neural network uses the quantile pooling method of the invention to identify salient features of the point cloud and signals to improve detection precision. The high efficiency and superior performance of the quantile pooling method of the invention ensure its seamless integration on edge devices such as one or more edge servers in the V2X edge system. Data from individual vehicles and infrastructure sensors are aggregated at roadside processing units. A decision-making model that incorporates the quantile pooling method of the invention is utilized to merge individual observations, which enhances the V2X edge system's ability to discern patterns and make traffic management decisions more accurate and reliable.

The input space for the quantile pooling method of the invention comprises the plurality of sensors in V2X traffic system of FIG. 13, the plurality of sensors providing point cloud data on traffic events to the decision-making module of the V2X traffic system.

The invention also provides a non-transitory computer-readable medium storing machine-readable instructions, wherein, when the machine-readable instructions are executed by a processor, they configure the processor to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A computer implemented method of data pooling in a neural network comprising:
receiving an input tensor formed from a set of data points obtained from an input space, the input tensor having a plurality of input space dimensions;
segmenting the input tensor over each of its input space dimensions into equal-sized segments, each set of corresponding segments over the input space dimensions comprising a partition;
determining, selecting, or calculating a respective quantile level for each partition;
determining or calculating a quantile value for each segment based on the quantile level for its partition; and
creating a pooled output vector by concatenating the quantile values for the segments of each partition, the output vector comprising a pooled output for each partition.

2. The method of claim 1, wherein the quantile values for each segment are determined by:
sorting the data within the segments of each partition until pivot elements are sorted into their final, sorted positions; and
interpolating the values of data in the segments of each partition to estimate the quantile values for each segment.

3. The method of claim 1, wherein the method includes preparing or compiling the set of data points obtained from the input space into the input tensor.

4. The method of claim 1, wherein the respective quantile levels for the partitions are calculated from a predetermined or learned rule.

5. The method of claim 1, wherein different respective quantile levels for the partitions are determined, selected, or calculated.

6. The method of claim 1, wherein the respective quantile levels for the partitions are derived from a density function.

7. The method of claim 1, wherein the quantile range is adjustable.

8. The method of claim 7, wherein the quantile range is adjustable to provide a custom data pooling function for the neural network.

9. The method of claim 7, wherein a probability density function ƒ_{νq} for a quantile range for the respective quantile levels comprises a Dirac delta function δ(p−q) centred on q with a quantile range q+/−∈[q−∈, q+∈].

10. The method of claim 7, wherein the quantile range is:
concentrated close to a value 1 to approximate a maximum pooling operation; or
distributed uniformly from value 0 to value 1 to approximate an average pooling operation; or
selected to have a high quantile interval center and a wide quantile interval to enhance versatility in capturing data features and data distribution; or
the quantile levels within the quantile range are learned via a learning algorithm with the probability density function ƒ_{νq} for the quantile range is non-uniformly distributed from value 0 to value 1.

11. The method of claim 1, wherein the input space comprises a plurality of sensors in a vehicle-to-everything (V2X) traffic system, the plurality of sensors providing point cloud data on traffic events to a decision-making module of the V2X traffic system, the decision-making module configured to implement the quantile data pooling method of claim 1.

12. The method of claim 11, wherein the decision-making module is implemented in one or more edge servers of the V2X traffic system.

13. A neural network incorporating a quantile pooling layer for permutation-equivariant set data analysis, the neural network comprising:
means for receiving an input tensor comprising a set of unordered data points;
means for processing the input tensor through one or more permutation-equivariant transformations and/or one or more non-linear layers; and
means for processing the input tensor through a quantile pooling layer to produce a pooled output to provide a pooled output vector;
wherein the means for processing the input tensor through a quantile pooling layer is configured to implement the steps of:
receiving an input tensor formed from a set of data points obtained from an input space, the input tensor having a plurality of input space dimensions;
segmenting the input tensor over each of its input space dimensions into equal-sized segments, each set of corresponding segments over the input space dimensions comprising a partition;
determining, selecting, or calculating a respective quantile level for each partition;
determining or calculating a quantile value for each segment based on the quantile level for its partition; and
creating a pooled output vector by concatenating the quantile values for the segments of each partition, the output vector comprising a pooled output for each partition.

14. The neural network of claim 13, further comprising means for concatenating the pooled output vector with or without the input tensor to provide a concatenated tensor.

15. The neural network of claim 14, further comprising means for processing the concatenated tensor or the pooled output vector through one or more element-wise transformations.

16. The neural network of claim 13, wherein the means for processing the input tensor through the quantile pooling layer is configured to process the input tensor through multiple quantile pooling layers.

17. The neural network of claim 16, wherein the each quantile pooling layer uses a different quantile level or quantile range.

18. The neural network of claim 16, further comprising a learning algorithm.

19. A computer-implemented system for set data analysis, the computer system comprising:
means for collecting a set of data points;
means for performing permutation-equivariant transformations and quantile pooling on the collected data points; and
means for utilizing the output vector or tensor to implement operations or tasks involving set-structured data;
wherein the means for performing permutation-equivariant transformations and quantile pooling on the collected data points is configured to perform the steps of:
receiving at the means for collecting a set of data points an input tensor comprising a set of unordered data points;
processing the input tensor through one or more permutation-equivariant transformations and/or one or more non-linear layers; and
processing the input tensor through a quantile pooling layer to produce a pooled output to provide a pooled output vector;
wherein the step of processing the input tensor through a quantile pooling layer comprises the steps of:
receiving an input tensor formed from a set of data points obtained from an input space, the input tensor having a plurality of input space dimensions;
segmenting the input tensor over each of its input space dimensions into equal-sized segments, each set of corresponding segments over the input space dimensions comprising a partition;
determining, selecting, or calculating a respective quantile level for each partition;
determining or calculating a quantile value for each segment based on the quantile level for its partition; and
creating a pooled output vector by concatenating the quantile values for the segments of each partition, the output vector comprising a pooled output for each partition.

20. The computer-implemented system of claim 19, wherein the operations or tasks involving set-structured data comprise one or more of: self-driving vehicles; and smart transportation devices or systems.
